(19) United States
(12) Patent Application Publication
(10) Pub. No.: US 2002/0079653 A1
(43) Pub. Date: Jun. 27, 2002

(54) Portable electronic equipment

(76) Inventors: Kouichi Noguchi, Chiba-shi (JP); Katsunobu Iguchi, Chiba-shi (JP); Takashi Ito, Chiba-shi (JP)

Correspondence Address: ADAMS & WILKS, 31st FLOOR, 50 BROADWAY, NEW YORK, NY, 10004, US

(21) Appl. No.: 10/005,037

(22) Filed: Dec. 4, 2001

(30) Foreign Application Priority Data
Dec. 26, 2000 (JP) 2000-395865

(51) Int. Cl. F16J 15/02

(52) U.S. Cl. 277/628

(57) ABSTRACT

A water-resistant function can be maintained even in the case where a substrate is interposed between packings. Packing has a rib-shaped convex portion having a uniform height and width on a surface contacting a flexible substrate. The packing with such a convex portion is fitted in grooves provided in a body and a back cover. The rib-shaped convex portion disposed on the packing is biased to an edge portion of the substrate when a housing is closed, and is elastically deformed in a direction in which it comes into close contact with a side surface portion of the substrate. Thus, the convex portion disposed on the packing blocks up a gap generated in the vicinity of the side surface of the substrate and has a functional effect of suppressing water from entering.

### BACKGROUND OF THE INVENTION

1. Field of the Invention

The present invention relates to portable electronic equipment capable of maintaining a water-resistant function of a watch, a mobile phone, or the like.

2. Description of the Prior Art

In portable electronic equipment such as a watch and a mobile phone, it is required to keep a certain water-resistant function depending upon the use and function thereof. In order to realize this, generally, packing is interposed in a fitting portion of a housing so as to prevent water from entering from outside.

FIG. 10 is a perspective view showing a conventional water-resistant structure in portable electronic equipment that keeps electrical connection between the inside and the outside of a housing via a thin substrate. The portable electronic equipment includes a flexible substrate 1 having a terminal side 1a electrically connected to an internal module of a watch body and a terminal side 1b electrically connected to an external module such as a power source, a body 2 that is an external component incorporating movement, a back cover 3 of the body 2, and packings 4, 4 for preventing water, dust, and the like from entering the inside of the watch. The packing 4 is composed of a rubber-based member such as fluorine rubber, NBR rubber, or silicon rubber. Note that, the packing may have a cross section so that the substrate 1 and the body 2, and the substrate 1 and the back cover 3 come into contact with each other without any gap. Therefore, generally, the cross-section of the packing may have a relatively simple shape such as a circle and a square.

The packings 4 are fitted in respective grooves 5,5 provided in the body 2 and the back cover 3. The substrate 1 has a ring-shaped outer peripheral portion lc in accordance with the shape of the packing 4, so that the entire surface of the outer peripheral portion 1c is sandwiched on both sides thereof between the body 2 and the back cover 3 via the packings 4, 4 from upper and lower side directions. The body 2 and the back cover 3 are fixed to each other with screws, bolts, and the like. Thus, the substrate 1 is in contact with the packings 4, 4 without any gap due to a step difference or the like under the condition that the back cover 3 is attached to the body 2, whereby a predetermined water-resistant function is exhibited.

[Problems To Be Solved By The Invention]

However, in the above-mentioned conventional water-resistant structure, the substrate 1 is provided along the outer periphery of the body 2, so that the outer periphery of the body 2 is also required to have an area contacting the substrate 1 so as to fix it. This increases the size of the body 2. Furthermore, since the outer peripheral portion does not require electrical connection, the shape becomes complicated and a cost is increased.

On the other hand, when the outer peripheral portion 1c is removed from the substrate 1, and the back cover is attached to the body 2 with the same structure as the above, the thickness of the substrate 1 causes a gap between the substrate 1 and the packings 4, 4, which even a rubber based member cannot follow, and sufficient water-resistant performance cannot be ensured. This will be described in detail with references to FIGS. 11, 12, and 13. Even the flexible thin substrate 1 has a predetermined thickness, so that the cross-section thereof generally has an elongated rectangular shape. Thus, in the case where the cover 3 is attached to the body 2, the packing 4 is elastically compressed excessively by the thickness of the substrate 1, compared with the other portions, which causes a concave 6. As a result, a gap 10 is generated in the vicinity of a side surface portion 8 of the substrate 1, which is surrounded by the side surface portion 8 of the substrate 1 and surfaces 9 of the packings 4, 4. In particular, in the case where the thickness of the substrate 1 is relatively large (e.g., 0.1 mm or more), the gap 10 becomes very large, which makes it difficult to maintain a water-resistant function.

On the other hand, it is considered that the gap 10 is filled with a sealant such as an adhesive so as to ensure water-resistance. However, the fitting portion of the housing is firmly fixed, so that it becomes difficult to conduct maintenance such as repairment and exchange of components.

### SUMMARY OF THE INVENTION

The present invention has been made in view of the above, and an object of the present invention is to provide portable electronic equipment capable of maintaining a water-resistant function even in the case where a substrate is interposed between packings.

The problem of the conventional portable electronic equipment is that a large gap 10 is generated in the vicinity of a side surface portion 8 of a substrate. This is caused by the following. Since a contact surface between the packing 4 and the substrate 1 is too large, the packing 4 cannot be elastically deformed so as to come into close contact with the side surface portion 8. Therefore, in order to avoid the generation of the gap 10, a convex portion is disposed on the surface of the packing 4, which is capable of being elastically deformed so as to flexibly correspond to the step difference approximately with a thickness of the substrate 1, whereby the convex portion blocks up the gap.

The present invention relates to a portable electronic equipment, which includes: a housing accommodating an internal module; a thin substrate electrically connecting the internal module to an external module outside of the housing; and packing made of an elastic member and having a rib-shaped convex portion that is elastically deformed so as to come into close contact with a side surface portion of the thin substrate at least in a portion of a surface where the thin substrate is to be interposed, wherein the housing has a fitting portion for sandwiching the packing for sealing.

The convex portion disposed on the packing 4 follows and comes into close contact with the edge portion 8 of the substrate 1 when the substrate 1 is interposed, and blocks up the gap 10 generated in the vicinity of a side surface portion of the substrate 1 (see FIG. 2). By blocking up the gap 10, even in the case where the substrate 1 is interposed between the packings 4, a water-resistant function can be maintained. Therefore, the inside of the electronic equipment can be suppressed from being soaked in water.

In the present invention, the term “so as to come into close contact with” does not refer to that the convex portion completely comes into close contact with the side surface portion 8. More specifically, an object of the present invention is to suppress water soaking phenomenon occurring due to the generation of the gap 10. The water-resistance is varied depending upon the use, function, or specification of electronic equipment. Therefore, the degree to which the convex portion provided on the packing 4 is elastically deformed “so as to come into close contact with” the side surface portion 8 may be enough to fall within a range capable of achieving the object.

The present invention relates to a portable electronic equipment, which includes: a housing accommodating an internal module; a thin substrate electrically connecting the internal module to an external module outside of the housing; and packing made of an elastic member and having a rib-shaped convex portion along a longitudinal direction of a surface thereof and a step portion corresponding to a width of the thin substrate on a part of the convex portion, wherein the housing has a fitting portion for sandwiching the packing for sealing.

The present invention relates to a portable electronic equipment, wherein a cut-away portion is provided in an side edge portion of the thin substrate, and a step portion corresponding to a width of a portion where the cut-away portion is disposed is provided in a part of the convex portion.

Furthermore, a step portion corresponding to a width of the substrate 1 may be provided on a part of the convex portion. By passing the substrate 1 through the step portion, the packing 4 may be allowed to follow the side surface portion 8 of the substrate 1. Because of this, a water-resistant function can be further enhanced. Furthermore, it may also be possible that a cut-away portion is provided in a side edge portion of the substrate 1, and a step portion corresponding to a width of a portion where the cut-away portion is disposed is provided in a part of the convex portion. Because of this, even in the case where the substrate 1 is interposed between the packings 4, the position of the substrate 1 can be fixed, and seal between the packing 4 and the substrate 1 becomes unlikely to be broken.

### BRIEF DESCRIPTION OF THE SEVERAL VIEWS OF THE DRAWINGS

A preferred form of the present invention is illustrated in the accompanying drawings in which:

FIG. 1 is a perspective view showing a water-resistant structure of electronic equipment in accordance with Embodiment 1 of the present invention;

FIG. 2 is a cross-sectional view taken along the line I-I of FIG. 1;

FIG. 3 is a side view of FIG. 2;

FIG. 4 is a perspective view of packing shown in FIG. 1;

FIG. 5 is a cross-sectional view taken along the line II-II of FIG. 4;

FIG. 6 is a perspective view showing a water-resistant structure of electronic equipment in accordance with Embodiment 2 of the present invention;

FIG. 7 is a cross-sectional view taken along the line III-III of FIG. 6;

FIG. 8 is a side view of FIG. 7;

FIG. 9 is a perspective view showing a water-resistant structure of electronic equipment in accordance with Embodiment 3 of the present invention;

FIG. 10 is a perspective view showing a water-resistant structure in conventional watch-type portable equipment;

FIG. 11 is a perspective view showing a water-resistant structure in conventional watch-type portable equipment;

FIG. 12 is a cross-sectional view taken along the line IV-IV of FIG. 11; and

FIG. 13 is a side view of FIG. 12.

### DETAILED DESCRIPTION OF THE PREFERRED EMBODIMENTS

Hereinafter, the present invention will be described in detail with reference to the drawings. It should be noted that the present invention is not limited by the following embodiments.

(Embodiment 1)

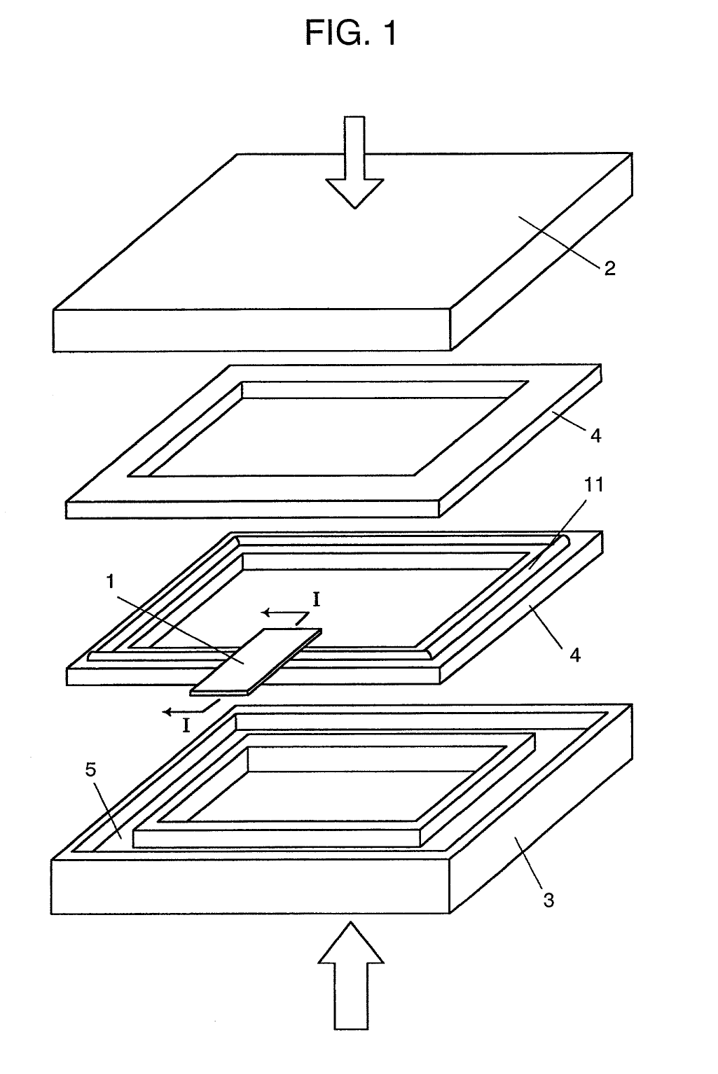

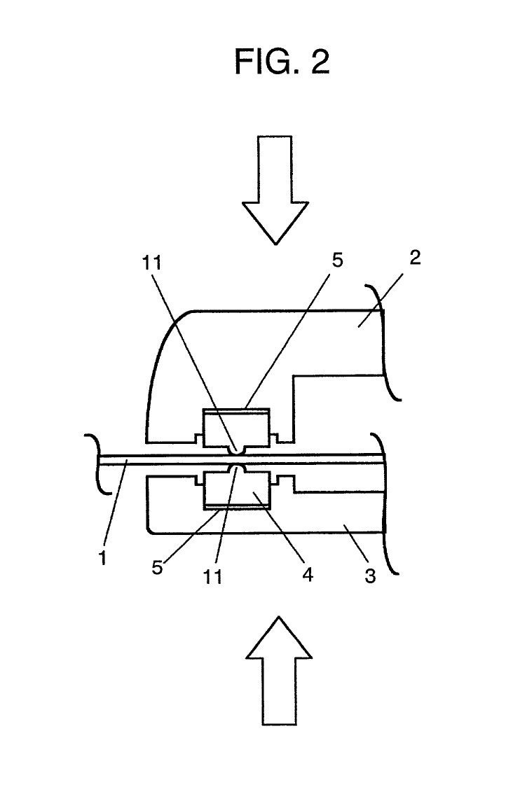

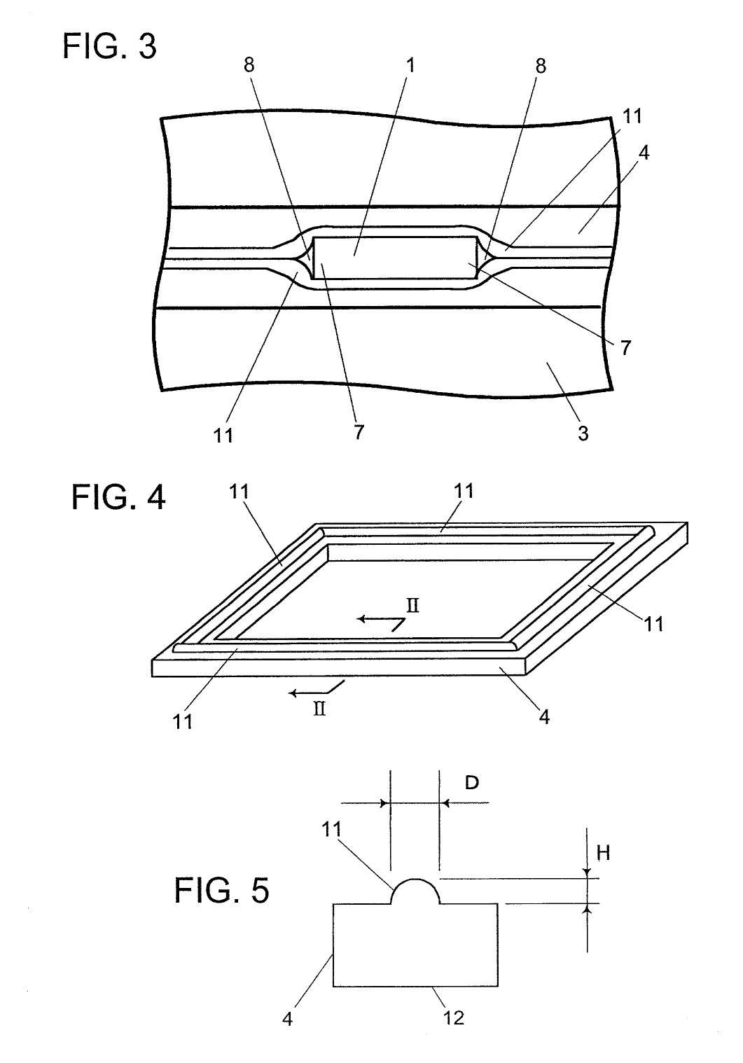

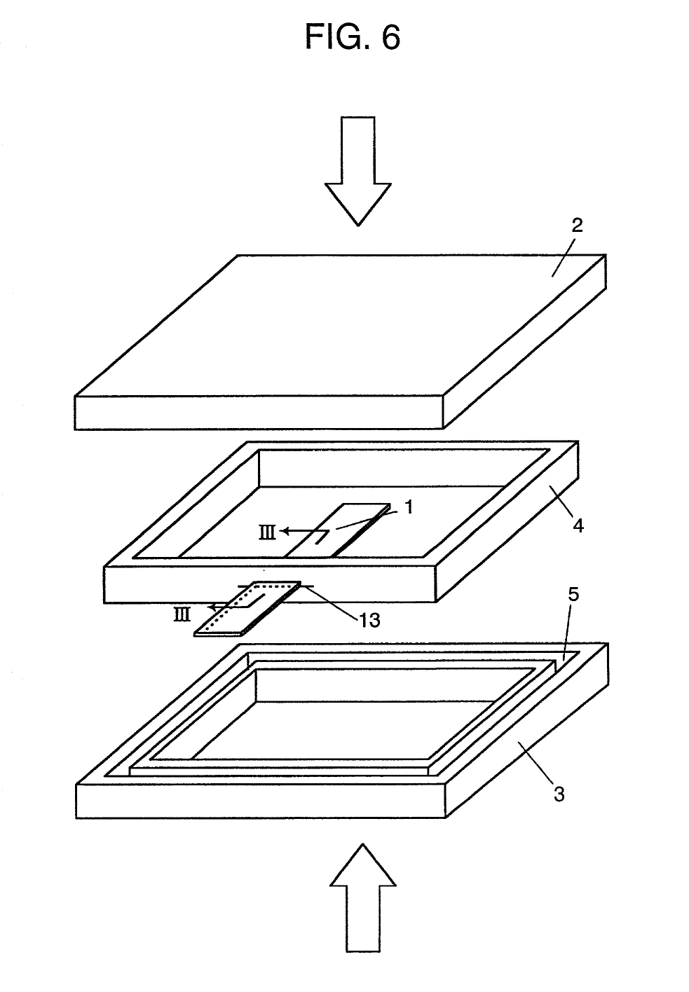

FIG. 1 is a perspective view showing a water-resistant structure of electronic equipment in accordance with Embodiment 1 of the present invention. FIG. 2 is a cross-sectional view taken along the line I-I of FIG. 1, and FIG. 3 is a side view of FIG. 2. Furthermore, FIG. 4 is a perspective view of the packing shown in FIG. 1, and FIG. 5 is a cross-sectional view taken along the line II-II of FIG. 4. The same components as those shown in FIG. 10 are denoted with the same reference numerals as those therein, and the description thereof will be omitted. The packing 4 has a structure in which a rib-shaped convex portion 11 with a uniform height H and width D is provided on the surface contacting the substrate 1. Furthermore,the convex portion 11 has a semi-spherical shape in cross-section and is provided along the entire periphery of the packing 4 along the length direction of the packing 4, as shown in FIGS. 4 and 5. The height H and width D and material of the convex portion 11 are determined so as to flexibly correspond to the step difference on the order of the thickness of the substrate 1 by elastic deformation.

The packings 4, 4 having the convex portion 11 are fitted in the grooves 5, 5 provided in the body 2 and the back cover 3. In this state, the convex portions 11, 11 of the upper and lower packings 4, 4 are positioned so as to be opposed to each other. Furthermore, by setting the cross-section of the packing 4 in a substantially rectangular shape, in the case where the packing 4 is fitted in the groove 5, the packing 4 can be stably supported. The cross-section of packings 4, 4 is not limited to a substantially rectangular shape, and may be a circle, a trapezoid, or the like. Furthermore, the shape of a bottom surface portion 12 thereof may have a convex curved surface.

When the substrate 1 is interposed between the packings 4, 4 so as to sandwich the substrate 1 between the packings 4, 4, the packings 4, 4 are elastically deformed along the substrate 1, and the convex portion 11 flexibly follows the shape of the substrate 1, whereby the packings 4, 4 come into close contact with the side surface portion 8 of the substrate 1. Because of this, the gap 10 is blocked. Therefore, even in the case where the substrate 1 is interposed, a water-resistant function can be maintained. Furthermore, by providing the convex portion 11 along the entire periphery of the packing 4, even in the case where the posture of the substrate 1 is slightly shifted in incorporation, the convex portion 11 comes into close contact with an edge portion 7 of the substrate 1. Therefore, a water-resistant function is not impaired by the positional shift of the substrate 1.

The size and the like of the convex portion 11 can be appropriately determined by the specification of electronic equipment adopting the above-mentioned water-resistant structure. The height of the convex portion 11 is set, for example, so as to be larger than a half of the thickness of the substrate 1 and smaller than a clamping portion of the packing 4. The clamping portion of the packing 4 refers to a crushed amount per packing when the body 2 and the backcover 3 are fixed with a screw (not shown). By setting the height of the convex portion 11 so as to fall within such a range, a necessary and sufficient water-resistant function can be ensured in portable equipment such as a watch.

It is preferable that the ratio of the width to the height of the convex portion 11 is set to be a value slightly larger than 1 so as to avoid the situation that the convex portion 11 falls when the substrate 1 is interposed. Furthermore, the width of the convex portion 11 should not be set so large as to lose the above-mentioned function. The water-resistant structure of the present invention is characterized in that the convex portion 11 provided on the packing 4 is elastically deformed to come into close contact with the edge portion 7 of the substrate 1, thereby blocking up the gap 10 generated in the vicinity of the side surface 8. In the case where the width of the convex portion 11 is set to be too large, the convex portion 11 becomes unlikely to come into close contact with the edge portion 7.

Furthermore, the convex portion 11 provided on the packing 4 preferably has a substantially semi-arc shape in cross-section (see FIG. 4). Water-resistant defects are likely to occur when the convex portion 11 falls in interposing the substrate 1 or when the convex portion 11 comes into contact with the substrate 1 at an unstable angle. In contrast, by setting the cross-section of the convex portion to a substantially semi-arc shape, the convex portion 11 becomes unlikely to fall, and sealing performance is allowed to be uniformly exhibited even when the convex portion 11 comes into contact with the substrate 1 at an unstable angle. The cross-sectional shape of the convex portion 11 is not limited to the above-mentioned substantially semi-arc shape, and can be other geometric shapes such as a substantially rectangular or trapezoidal shape. Furthermore, the convex portion 11 may be provided in double or triple. With this, water-resistant performance can be further enhanced. Furthermore, the convex portion 11 may be provided on only one packing 4 so as to simplify the structure.

(Embodiment 2)

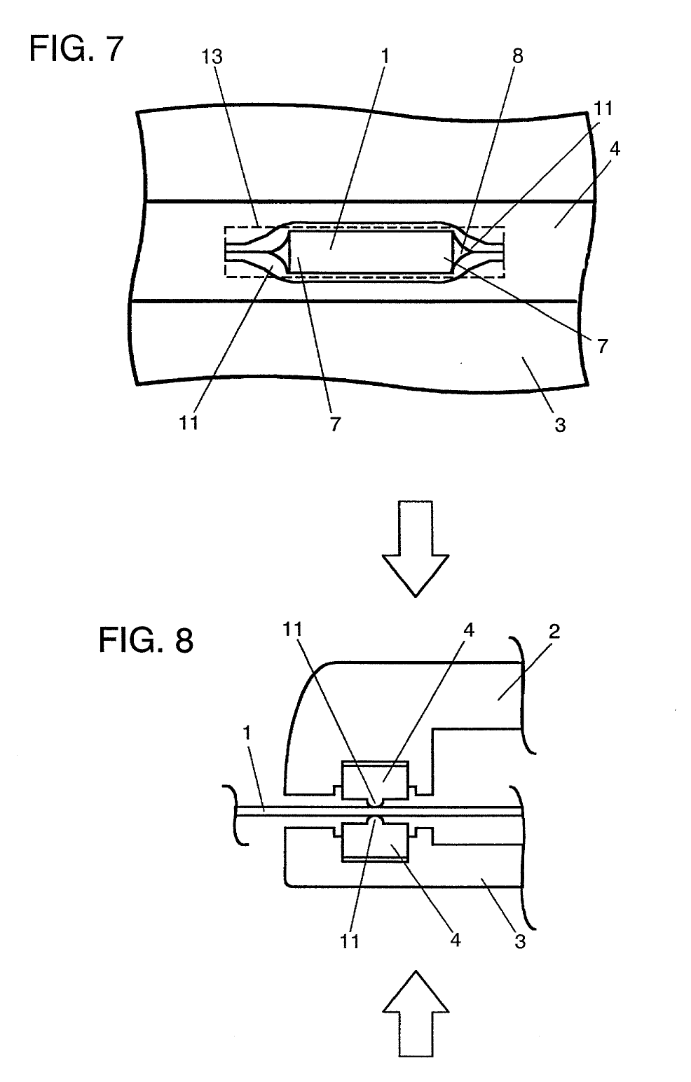

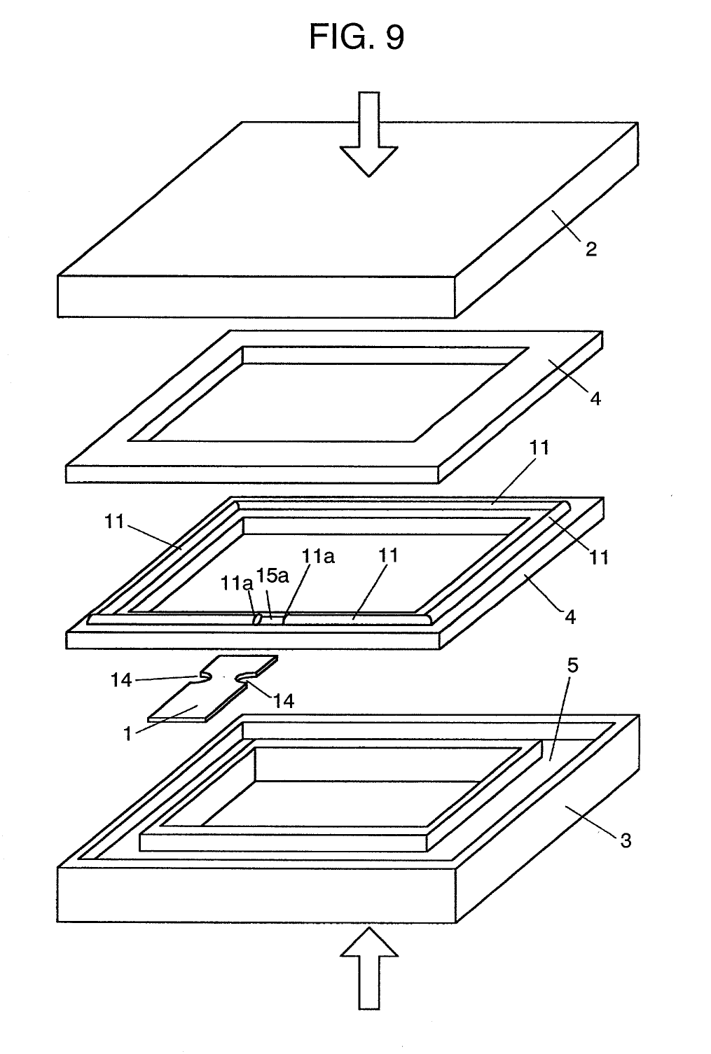

FIG. 6 is a perspective view showing a water-resistant structure of electronic equipment in accordance with Embodiment 2 of the present invention. FIG. 7 is a cross-sectional view taken along the line III-III of FIG. 5. FIG. 8 is a side view of FIG. 6. The packing 4 is provided with a slit 13 on a side surface portion in an insertion direction of the substrate 1. The inner wall surface of the slit 13 is provided with the convex portion 11 that can be biased to the edge portion 7 of the substrate 1 when the housing is in a closed state and can be elastically deformed so as to come into close contact with the side surface portion 8 of the substrate 1. The convex portion 11 disposed on the packing 4 is biased to the edge portion 7 of the substrate, and is elastically deformed so as to come into close contact with the side surface portion 8 of the substrate (the slit 13 before deformation is represented by a dotted line), in the same way as in the case described in Embodiments 1 and 2. Consequently, the gap 10 generated in the vicinity of the side surface of the substrate 1 can be blocked to prevent water from entering.

(Embodiment 3)

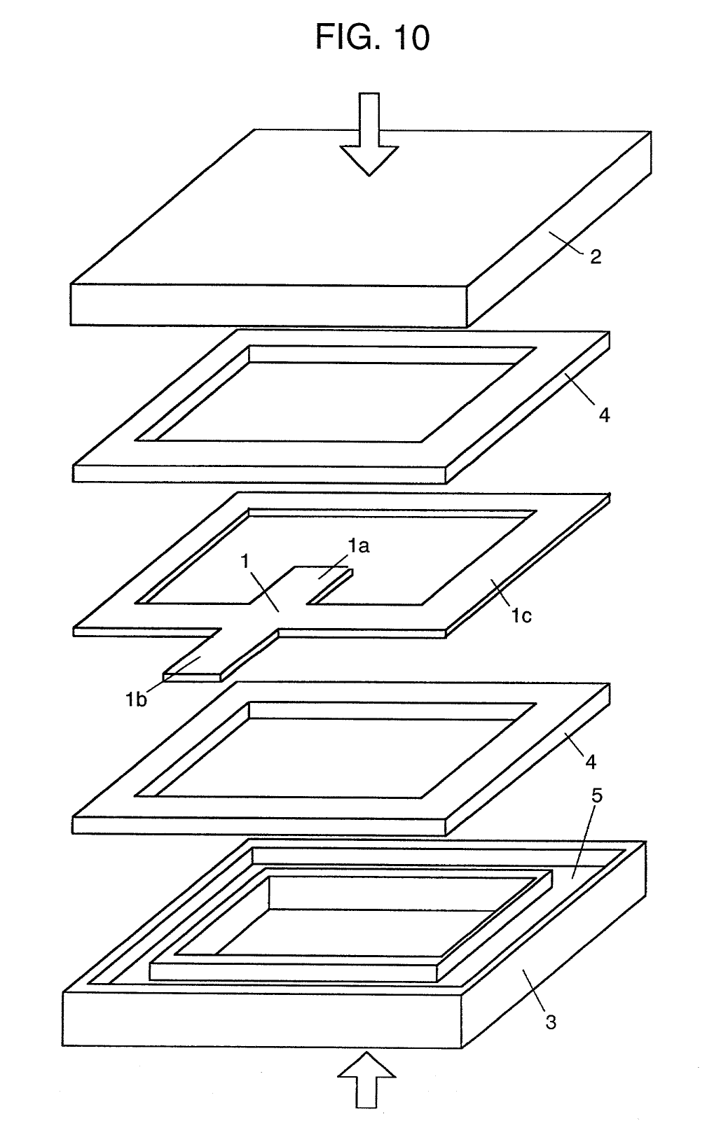

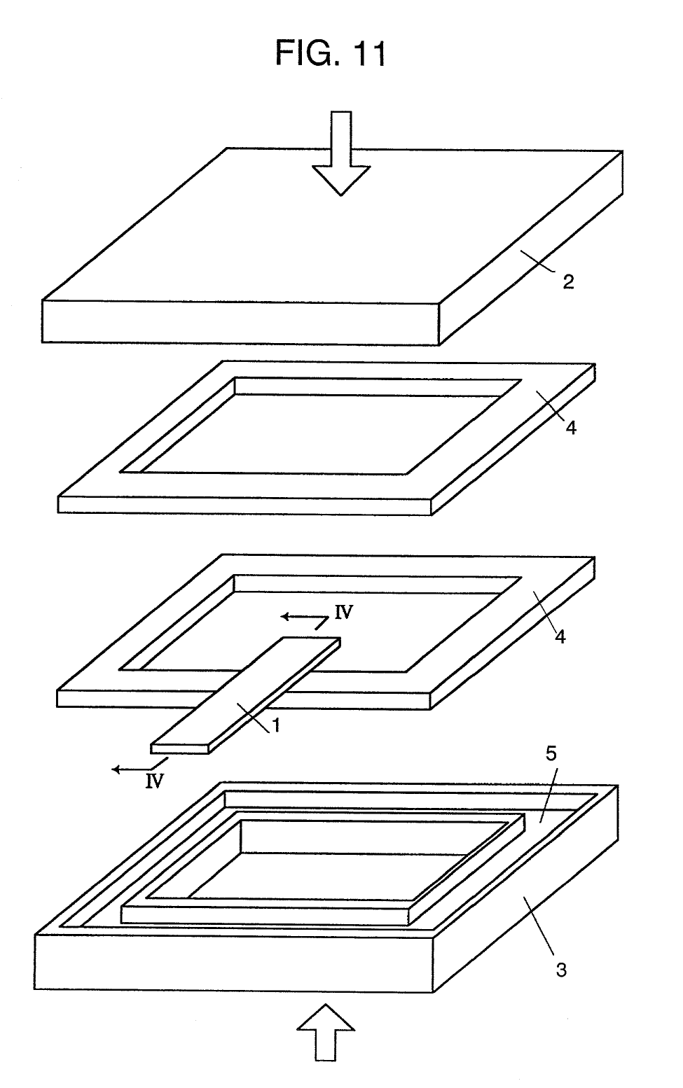

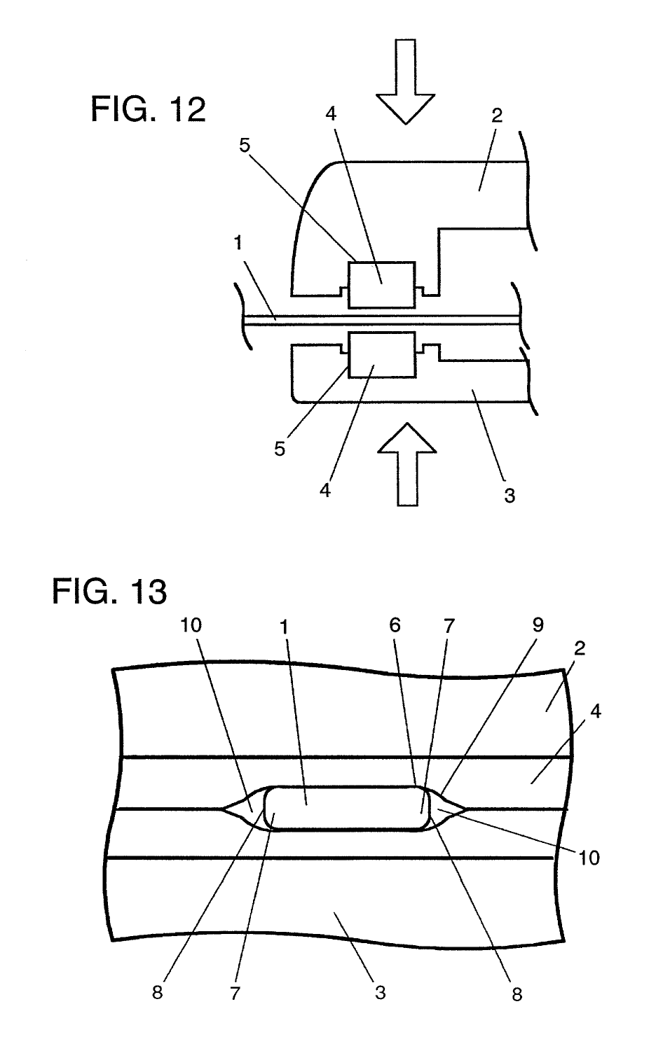

FIG. 9 is a perspective view showing a water-resistant structure of electronic equipment in accordance with Embodiment 3 of the present invention. This water-resistant structure is characterized in that a cut-away portion 14 is formed in the substrate 1, and a step portion 15 is formed on the convex portion 11. The other configurations are the same as those of the water-resistant structure of Embodiment 1, so that the same components as those therein are denoted with the same reference numerals as those therein, and the description thereof will be omitted here. The substrate 1 is provided with the cut-away portion 14 with the same width as that of the convex portion 11 (see FIG. 5) disposed on the packing 4. Furthermore, the convex portion 11 is provided with the step portion 15 having the same width as the horizontal width of the substrate 1 in the cut-away portion 14.

In the case where the substrate 1 is fitted in the step portion 15 so as to be interposed between the packings 4, the end portion 11a of the convex portion 11 is engaged with the cut-away portion 14 of the substrate 1 and biases the packing 4, whereby the convex portion 11 is crushed. Because of this, the convex portion 11 comes into close contact with the side surface of the substrate 1 to block up the gap of the side portion, whereby the inside of the housing is rendered waterproof. With this, in the case where the substrate 1 is interposed between the packings 4, the position of the substrate 1 can be fixed, and seal between the packing 4 and the substrate 1 becomes unlikely to be broken.

Furthermore, a cut-away portion 15 (not shown) may be provided only on the convex portion 11 by eliminating the cut-away portion 14 of the substrate 1. Even with this, the end portion 11a of the convex portion 11 becomes likely to follow the side surface portion 8 of the substrate 1, and a water-resistant function can be enhanced accordingly.

As described above, in the portable electronic equipment according to the present invention, a rib-shaped convex portion is provided, which is elastically deformed so as to come into close contact with the side surface portion of a thin substrate, at least on a portion of the packing surface where the thin substrate is to be interposed. Therefore, even in the case where the thin substrate is interposed between the packings, a water-resistant function can be maintained, so that the inside of the electronic equipment can be suppressed from being soaked in water.

Furthermore, in the portable electronic equipment of the present invention, a rib-shaped convex portion is provided on the packing surface along its longitudinal direction, and a step portion corresponding to a width of the thin substrate is provided on a part of the convex portion. Therefore, the convex portion is likely to come into close contact with the thin substrate, whereby a water-resistant function can be further maintained.

Furthermore, in the portable electronic equipment of the present invention, a cut-away portion is provided in a side edge portion of a thin substrate, and a step portion corresponding to a width of a portion where the cut-away portion is disposed is provided on a part of the convex portion. Therefore, the position of the thin substrate can be fixed. Therefore, even in the case where a thin substrate is interposed between the packings, a water-resistant function can be maintained, and seal between the packing and the thin substrate becomes unlikely to be broken.

What is claimed is

1. A portable electronic equipment, comprising:
a housing accommodating an internal module;
a thin substrate electrically connecting the internal module to an external module outside of the housing; and
a packing made of an elastic member and having a rib-shaped convex portion that is elastically deformed so as to come into close contact with a side surface portion of the thin substrate at least in a portion of a surface where the thin substrate is to be interposed,
wherein the housing has a fitting portion for sandwiching the packing for sealing.

2. A portable electronic equipment, comprising:
a housing accommodating an internal module;
a thin substrate electrically connecting the internal module to an external module outside of the housing; and
packing made of an elastic member and having a rib-shaped convex portion along a longitudinal direction of a surface thereof and a step portion corresponding to a width of the thin substrate on a part of the convex portion,
wherein the housing has a fitting portion for sandwiching the packing for sealing.

3. A portable electronic equipment according to claim 2, wherein a cut-away portion is provided in an side edge portion of the thin substrate, and a step portion corresponding to a width of a portion where the cut-away portion is disposed is provided in a part of the convex portion.
